(19) United States
(12) Patent Application Publication
(10) Pub. No.: US 2025/0085861 A1
(43) Pub. Date: Mar. 13, 2025

(54) SYSTEMS AND METHODS FOR IMPROVING MEMORY WRITE PERFORMANCE

(71) Applicant: QUALCOMM INCORPORATED, San Diego, CA (US)

(72) Inventors: Santhosh Reddy AKAVARAM, Hyderabad (IN); Chintalapati BHARATH SAI VARMA, Hyderabad (IN); Prakhar SRIVASTAVA, Lucknow (IN); Sri Ananda Sai JANNABHATLA, Hyderabad (IN); Reddy Vijay GUDI, Hyderabad (IN)

(21) Appl. No.: 18/464,874

(22) Filed: Sep. 11, 2023

(51) Int. Cl. G06F 3/06; G06F 12/10

(52) U.S. Cl. CPC G06F 3/0616; G06F 3/0656; G06F 3/0679; G06F 12/10

(57) ABSTRACT

Systems and methods improve write performance of a UFS device comprising N logical units (LUNs) and N write buffers (WBs), where N is a positive integer. Each WB is mapped to a respective LUN. Each WB has a respective WB lifetime estimate value and a respective WB lifetime threshold (TH) value. A determination is made as to whether the WB lifetime estimate value associated with at least a first WB of the N WBs is equal to or is greater than the respective WB TH value, and if so, the first WB is remapped to a second LUN of the N LUNs and a second WB of the N WBs is remapped to the first LUN. The remapping is based at least in part on the WB lifetime estimate value associated with the second WB indicating that the second WB has more lifetime remaining than the first WB.

### DESCRIPTION OF THE RELATED ART

A computing device may include multiple processor-based subsystems. Such a computing device may be, for example, a portable computing device (“PCD”), such as a laptop or palmtop computer, a cellular telephone or smartphone, a portable digital assistant, a portable game console, etc. Still other types of PCDs may be included in automotive and Internet-of-Things (“IoT”) applications. A computing device may also be a stationary computer, such as a personal computer (PC) or various types of desktop computers or workstation computers.

Such processor-based subsystems may be included within the same integrated circuit chip or in different chips. A “system-on-a-chip”, or “SoC”, is an example of one such chip that integrates numerous subsystems to provide system-level functionality. For example, an SoC may include one or more types of processors, such as central processing units (“CPU”s), graphics processing units (“GPU”s), digital signal processors (“DSP”s), and neural processing units (“NPU”s). An SoC may include other subsystems, such as a transceiver or “modem” subsystem that provides wireless connectivity, a memory subsystem, etc.

Computing devices also include various types of memory devices that are used by the processing units for storing data and computer instructions, including Universal Flash Storage (UFS) devices. UFS devices often include NOR or NAND flash memory devices. Two types of NAND flash memory devices that are commonly found in computing devices today include single-level-cell (SLC) NAND flash memory devices and triple-level-cell (TLC) NAND flash memory devices. SLC NAND flash memory devices store a single bit of information per cell, either a 0 or 1. As a result, the data can be written to and retrieved from SLC NAND flash memory at very high speed. TLC NAND flash memory stores 3 bits per cell. Adding more bits per cell reduces cost and increases capacity, but negatively impacts performance and endurance. Many consumer products use TLC NAND flash memory because it is less expensive than TLC NAND flash memory.

SLC NAND flash memory has better performance and higher endurance than TLC NAND flash memory, having a life expectancy of 100,000 program/erase (P/E) cycles compared to 3,000 P/E cycles for TLC NAND flash memory. However, because SLC NAND flash memory is more expensive than TLC NAND memory, it is not commonly used in consumer products. It is typically used for servers and for other industrial applications that require high speed and endurance.

Write performance of TLC NAND flash memory devices is much lower than write performance of SLC NAND flash memory devices due to the greater number of bits per cell. To overcome this lower write performance of TLC NAND flash memory, it is known for a main memory portion of the UFS device to comprise TLC NAND flash memory and for a smaller turbo write buffer of the UFS device to comprise SLC NAND flash memory. The SLC NAND flash turbo write buffer receives data with higher throughput than the TLC NAND flash memory. Using SLC NAND flash memory as a turbo write buffer enables a write request to be processed with lower latency, leading to an overall improvement in the write performance of the UFS device. Data written to the turbo write buffer is typically flushed into the TLC NAND flash memory portion by an explicit command of the host processor of the computing device or implicitly while the computing device is in a hibernate (HIBERN8) state.

Although the endurance of SLC NAND flash memory is much greater than TLC NAND flash memory, because the size of the SLC turbo write buffer is very small compared to the size of the TLC NAND flash memory of the UFS device, the same block addresses of the turbo write buffer are updated more often than the block addresses of the TLC NAND flash memory portion, which can lead to the turbo write buffer becoming exhausted before the TLC NAND flash memory portion becomes exhausted. There is a limit to how many P/E cycles a block of flash memory can accept before it produces errors or fails altogether. Each P/E cycle causes a flash memory cell's oxide layer to deteriorate. Because the smaller size of the turbo write buffer can result in its blocks experiencing more P/E cycles than the blocks of the TLC NAND flash memory portion, the turbo write buffer of the UFS device may become exhausted (i.e., unable to properly retain data) before the TLC NAND flash memory portion of the UFS device becomes exhausted.

A need exists for a way to prevent or at least delay exhaustion of the turbo write buffer.

### SUMMARY OF THE DISCLOSURE

Systems, methods, and other examples are disclosed for improving write performance of a UFS device. The UFS device comprises N logical units (LUNs) and N write buffers (WBs). Each of the N WBs is mapped to a respective LUN of the N LUNs, where N is a positive integer that is greater than or equal to two. Each of the N WBs has a respective WB lifetime estimate value and a respective WB lifetime threshold (TH) value associated therewith. The N WB lifetime estimate values are indicative of an amount of lifetime remaining in the N WBs, respectively.

An exemplary embodiment of the method comprises:
determining whether the WB lifetime estimate value associated with at least a first WB of the N WBs is equal to or is greater than the respective WB TH value associated with the first WB; and
if a determination is made that the WB lifetime estimate value associated with the first WB is equal to or is greater than the WB TH value associated with the first WB, remapping the first WB to a second LUN of the N LUNs and remapping a second WB of the N WBs to the first LUN, the remapping being based at least in part on the WB lifetime estimate value associated with the second WB indicating that the second WB has more lifetime remaining than the first WB.

An exemplary embodiment of the system comprises a UFS device and a host processor. The UFS device comprises N LUNs, N WBs and control logic. The control logic is configured to determine whether any of the WB lifetime estimate values are equal to or are greater than the respective WB TH values. The host processor is configured to perform a remapping algorithm if a determination is made by the control logic that the WB lifetime estimate value associated with at least a first WB of the N WBs is equal to or is greater than the WB TH value associated with the first WB. The remapping algorithm remaps the first WB to a second LUN of the N LUNs and remaps a second WB of the N WBs to the first LUN, wherein the remapping is based at least in part on the WB lifetime estimate value associated with the second WB indicating that the second WB has more lifetime remaining than the first WB.

An exemplary embodiment of a computer program is embodied on a non-transitory computer-readable medium and comprises computer instructions for execution by a processor or controller for improving write performance of a UFS device. The computer program comprises first and second sets of instructions. The first set of computer instructions determines whether the WB lifetime estimate value associated with at least a first WB of the N WBs is equal to or is greater than the respective WB TH value associated with the first WB. If a determination is made that the WB lifetime estimate value associated with the first WB is equal to or is greater than the WB TH value associated with the first WB, the second set of computer instructions remaps the first WB to a second LUN of the N LUNs and remaps a second WB of the N WBs to the first LUN, wherein the remapping is based at least in part on the WB lifetime estimate value associated with the second WB indicating that the second WB has more lifetime remaining than the first WB.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1 illustrates a block diagram of a computing system in accordance with a representative embodiment for improving write performance of a UFS device.

FIG. 2 illustrates a block diagram of the computing system shown in FIG. 1 illustrating a turbo write buffer-to-logical unit (TWB-to-LUN) remapping in accordance with a representative embodiment.

FIG. 3 illustrates a block diagram of the system shown in FIGS. 1 and 2 that shows details of the UFS device in accordance with a representative embodiment for performing the TWB-to-LUN remapping tasks described with reference to FIG. 2.

FIG. 4 is a diagram showing the interaction between the host processor and the UFS device shown in FIGS. 1-3 in accordance with a representative embodiment to perform TWB-to-LUN remapping.

FIG. 5 is a flow diagram representing the method for improving write performance of a UFS device in accordance with a representative embodiment.

FIG. 6 illustrates an example of a PCD in which exemplary embodiments of systems, methods, computer-readable media, and other examples of the inventive principles and concepts of the present disclosure may be implemented.

### DETAILED DESCRIPTION

The present disclosure discloses systems and methods for improving write performance of a UFS device. The UFS device comprises N logical units (LUNs), N write buffers (WBs) and a main memory portion comprising flash memory cells, where N is a positive integer that is greater than or equal to two. Each of the N WBs is mapped to a respective LUN of the N LUNs, and each of the N WBs has a respective WB lifetime estimate value and a respective WB lifetime threshold (TH) value associated therewith. The N WB lifetime estimate values are indicative of an amount of lifetime remaining in the N WBs, respectively. A determination is made as to whether the WB lifetime estimate value associated with at least a first WB of the N WBs is equal to or is greater than the respective WB TH value associated with the first WB, and if so, the first WB is remapped to a second LUN of the N LUNs and a second WB of the N WBs is remapped to the first LUN. The remapping is based at least in part on the WB lifetime estimate value associated with the second WB indicating that the second WB has more lifetime remaining than the first WB.

In the following detailed description, for purposes of explanation and not limitation, exemplary, or representative, embodiments disclosing specific details are set forth in order to provide a thorough understanding of an embodiment according to the present teachings. The word “exemplary” is used herein to mean “serving as an example, instance, or illustration.” The words “illustrative” or “representative” may be used herein synonymously with “exemplary.” Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory device”, as that term is used herein, is intended to denote a non-transitory computer-readable storage medium that is capable of storing computer instructions, or computer code, for execution by one or more processors. References herein to a “memory device” should be interpreted as including one or more memory devices.

A “processor”, as that term is used herein encompasses an electronic component that is able to execute a computer program or executable computer instructions. References herein to a computer comprising “a processor” should be interpreted as one or more processors. The processor may for instance be a multi-core processor comprising multiple processing cores, each of which may comprise multiple processing stages of a processing pipeline. A processor may also refer to a collection of processors within a single system or distributed amongst multiple systems.

A computing device may include multiple subsystems, cores or other components. Such a computing device may be, for example, a PCD, such as a laptop or palmtop computer, a cellular telephone or smartphone, a portable digital assistant, a portable game console, an automotive safety system, etc., or a non-portable computing device (NPCD) such as, for example, a PC, a desktop or a workstation computer.

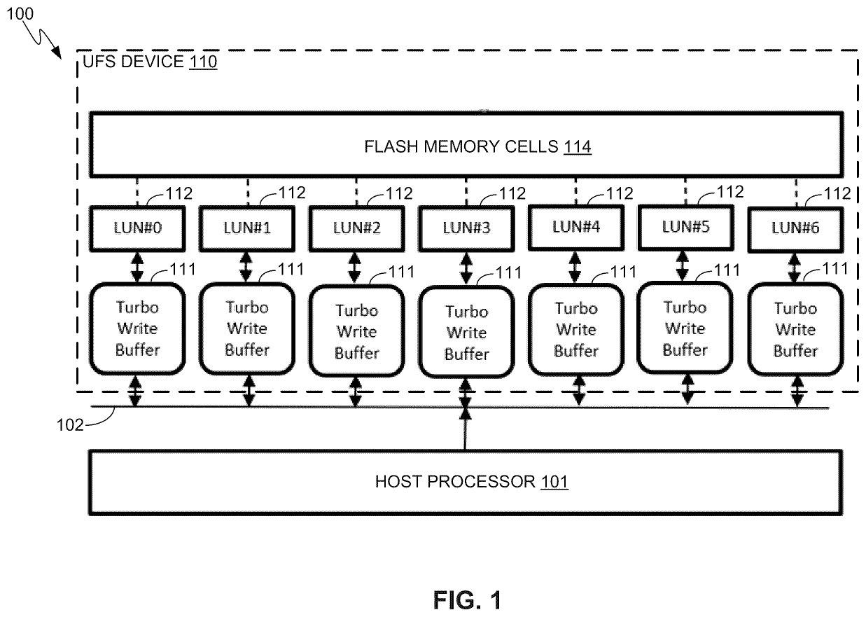

FIG. 1 illustrates a block diagram of a computing system 100 in accordance with a representative embodiment. A host processor 101 of the computing system 100 communicates over an interface 102 with a UFS device 110 comprising N SLC NAND flash turbo write buffers (TWBs) 111, N logical units (LUNs) 112 and flash memory cells 114, where N is a positive integer that is greater than or equal to two. In this representative embodiment, N=7 for purposes of describing an example of the inventive principles and concepts, and for ease of illustration.

The Joint Electron Device Engineering Council (JEDEC) UFS 4.0 standard was developed for mobile applications and computing systems requiring high performance with low power consumption. The standard introduces significant bandwidth and data protection improvement for UFS devices. In accordance with the JEDEC UFS 4.0 standard, the TWBs can be configured to operate in LUN “dedicated buffer” mode or in “shared buffer” mode to accommodate the UFS device's capability. In accordance with a preferred embodiment, the TWBs 111 are configured to operate in LUN dedicated buffer mode in which each TWB 111 is configured to perform buffering operations for a respective LUN 112. Each LUN 112 is associated with a respective group of the flash memory cells 114.

The JEDEC UFS 4.0 standard provides a bSupportedWriteBoosterBufferTypes descriptor that is a binary number that can be set to a particular value to indicate that the TWBs 111 are to operate in LU dedicated buffer mode. The JEDEC UFS 4.0 standard also provides a bDeviceMaxTurboWriteLUs geometry descriptor that is a binary number that can be set to a particular value to indicate the maximum number of supported TWBs 111.

In UFS devices, the utilization of each LUN 112/TWB 111 pair is not same for all the LUNs 112. The utilization varies from LUN 112 to LUN 112 based on the write requests received per LUN 112. In scenarios in which a LUN 112 handles nearly continuous write/erase operations, there is a high probability of stressing the respective TWB 111 to a greater extent than the other TWBs 111. If the additional stress on the TWB 111 continues for a long period of time, it can cause data decaying, decrease the data retention of the SLCs of the respective TWB 111, etc. Hence, the health of the TWB 111 deteriorates and can eventually result in write performance degradation to the point that using the TWB 111 is no longer advantageous.

In accordance with a representative embodiment, control logic of the UFS device 110 determines whether a lifetime estimate value associated with each TWB 111 is equal to or is greater than a respective TWB threshold (TH) value associated with the respective TWB 111, and if so, performs a TWB-to-LUN remapping. The TWB-to-LUN remapping remaps the TWB 111 to a LUN 112 that is currently paired with a TWB 111 having a lower TWB lifetime estimate value and remaps the TWB having the lower lifetime estimate value to the LUN 112 that is currently paired with the TWB 111 having the higher lifetime estimate value. Each lifetime estimate value is a metric of the amount of the lifetime of the respective TWB 111 that has already been consumed. Thus, a TWB lifetime estimate value approaching a respective TWB threshold value is an indication that the respective TWB may be nearing the end of its lifetime.

In accordance with a preferred embodiment, the TWB-to-LUN remapping remaps the TWB 111 that has a TWB lifetime estimate value that is equal to or greater than the respective TWB TH value to a LUN 112 that is currently paired with a TWB 111 having the lowest TWB lifetime estimate value of all of the TWB lifetime estimate values and remaps the TWB having the lowest TWB lifetime estimate value to the LUN 112 that is currently paired with the TWB 111 having the TWB lifetime estimate value that is greater than or equal to the respective TWB TH value.

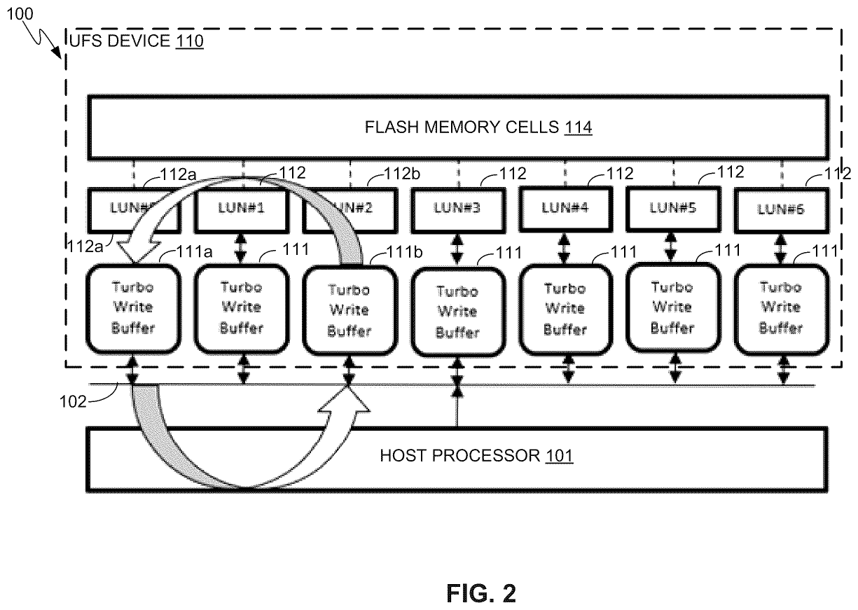

FIG. 2 illustrates a block diagram of the computing system 100 shown in FIG. 1 illustrating the TWB-to-LUN remapping in accordance with a representative embodiment. In the example shown in FIG. 2, it is assumed that a first TWB 111a has a first TWB lifetime estimate value associated with it that is greater than a second TWB lifetime estimate value associated with a second TWB 111b. The first TWB 111a is currently paired with a first LUN 112a and the second TWB 111b is currently paired with a second LUN 112b.

In accordance with this representative embodiment, control logic (not shown) of the UFS device 110 periodically compares the TWB lifetime estimate values associated with each of the TWBs 111 with the respective TWB TH values associated with the respective TWBs 111 and determines whether any of the TWB lifetime estimate values are equal to or greater than the respective TWB TH value. If so, the control logic notifies the host processor 101, which then instructs the control logic to send all of the TWB lifetime estimate values to the host processor 101. The host processor 101 then evaluates the TWB lifetime estimate values to determine which of the TWB lifetime estimate values is the smallest value, i.e., which of the TWBs 111 has the most lifetime remaining. The host processor 101 then instructs the control logic to remap, i.e., swap, the TWB 111 having the least lifetime remaining with the TWB 111 having the most lifetime remaining. In the example shown in FIG. 2, this results in TWB 111b being remapped to operate as a write buffer for LUN 112a and TWB 111a being remapped to operate as a write buffer for LUN 112b.

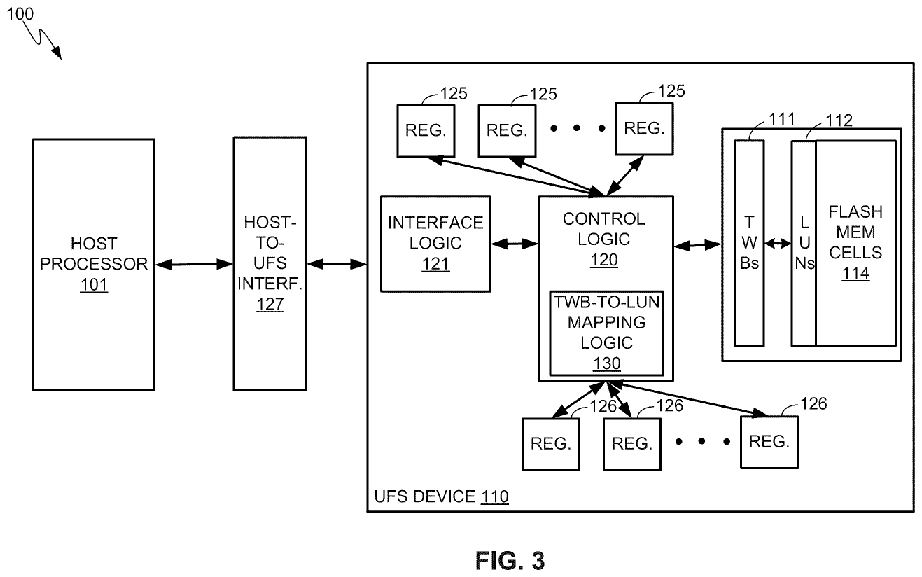

In the example given above, some of the tasks associated with determining whether a TWB-to-LUN remapping needs to be performed and with performing the remapping are performed by the host processor 101 and some are performed by the control logic of the UFS device 110. It should be noted that all of these tasks could be performed solely by the control logic of the UFS device 110, solely by logic of the host processor 101, by the host processor 101 and the UFS device 110, and/or by some other logical configuration. An exemplary embodiment of the portioning of these tasks will now be described with reference to FIG. 3.

FIG. 3 illustrates a block diagram of the system 100 shown in FIGS. 1 and 2 that shows details of the UFS device 110 in accordance with a representative embodiment for performing the TWB-to-LUN remapping tasks described above with reference to FIG. 2. UFS devices can have a variety of configurations. Therefore, it should be noted that the configuration shown in FIG. 3 is only one of many possible configurations, although all UFS devices typically have the components shown in FIG. 3, such as the control logic 120, the interface logic 121, the flash memory cells 114 and the LUNs 112. More recent UFS devices that are configured to operate in accordance with the JEDEC UFS 4.0 standard typically also include the TWBs 111.

In accordance with a representative embodiment, the control logic 120 comprises TWB-to-LUN remapping logic 130 and the UFS device 110 also comprises first and second sets of registers 125 and 126, respectively, for holding the TWB TH values and the TWB lifetime estimate values, respectively. In accordance with this representative embodiment, the control logic 120 periodically compares the TWB lifetime estimate values associated with each of the TWBs 111, which are stored in registers 125, with the respective TWB TH values associated with the respective TWBs 111, which are stored in registers 126 to determine whether any of the TWB lifetime estimate values are equal to or greater than the respective TWB TH value.

In accordance with a representative embodiment, if the control logic 120 determines that at least one of the TWB lifetime estimate values is equal to or greater than the respective TWB TH value, the control logic 120 notifies the host processor 101 of the comparison result via a host-to-UFS interface 127. The host processor 101 then instructs the control logic 120 to send all of the TWB lifetime estimate values stored in the registers 126 to the host processor 101. The host processor 101 then evaluates the TWB lifetime estimate values to determine which of the TWB lifetime estimate values is the smallest value, i.e., which of the TWBs 111 has the most lifetime remaining. The host processor 101 then instructs the control logic 120 to cause the TWB-to-LUN mapping logic 130 to remap, i.e., swap, the TWB 111 having the least lifetime remaining with the TWB 111 having the most lifetime remaining. As described above with reference to the example shown in FIG. 2, this results in TWB 111b being remapped to operate as a write buffer for LUN 112a and TWB 111a being remapped to operate as a write buffer for LUN 112b.

In accordance with a representative embodiment, the UFS device 110 comprises N 8-bit registers 125, where N refers to the number of LUNs 112 that are in the UFS device 110, and thus also refers to the number of TWBs 111 that are in the UFS device 110. Preferably, the 8-bit value of each register 125 indicates the following: 00h indicates that the TWB TH is disabled, and therefore the respective TWB 111 will perform with the legacy flow; 01h to 09h indicates that the TWB TH value is set to 10% to 90%, respectively; 0 Ah indicates that the TWB TH value is set to 100%.

Preferably, a TWBUtilLunThreshold[n][7:0] instruction is used by the control logic 120 to write and read the registers 125 and a bWriteBoosterBufferLifeTimeEst instruction is used to write and read the registers 126. If TWBUtilLunThreshold[n][7:0]=00h, this indicates that the respective TWB TH value is not set and therefore the respective TWB 111 will operate with the legacy flow.

If TWBUtilLunThreshold[n][7:0]=01h, this indicates that the TWB TH value is set to 10%, meaning that if the respective bWriteBoosterBufferLifeTimeEst value reaches 10%, the respective TWB 111 will be swapped with the least utilized TWB, i.e., with the TWB 111 associated with the lowest TWB life estimate value.

If TWBUtilLunThreshold[n][7:0]=02h, this indicates that the respective TWB TH value is set to 20%, meaning that if the respective bWriteBoosterBufferLifeTimeEst value reaches 20%, the respective TWB 111 will be swapped with the least utilized TWB 111.

If TWBUtilLunThreshold[n][7:0]=03h, this indicates that the respective TWB TH value is set to 30%, meaning that if the respective bWriteBoosterBufferLifeTimeEst value reaches 30%, the respective TWB 111 will be swapped with the least utilized TWB 111.

If TWBUtilLunThreshold[n][7:0]=09h, this indicates that the respective TWB TH value is set to 90%, meaning that if the respective bWriteBoosterBufferLifeTimeEst value reaches 90%, the respective the TWB 111 will be swapped with the least utilized TWB.

If TWBUtilLunThreshold[n][7:0]=10h, this indicates that the respective TWB TH value is set to 100%, meaning that if the respective bWriteBoosterBufferLifeTimeEst value reaches 100%, the respective TWB will be replaced with the least utilized TWB 111.

The registers 126 that hold the bWriteBoosterBufferLifeTimeEst values can be UFS device-specific registers that are referred to in the JEDEC UFS 4.0 standard. The bWriteBoosterBufferLifeTimeEst value is based on the amount of P/E cycles performed. The TWB lifetime is reduced as the number of P/E cycles performed increases. Thus, an increase in the bWriteBoosterBufferLifeTimeEst value, corresponds to a decrease in the remaining lifetime of the respective TWB 111. Once the bWriteBoosterBufferLifeTimeEst value reaches or exceeds, depending on the implementation scenario, the respective TWBUtilLunThreshold[n][7:0] value, this is an indication that it is time to swap out the respective TWB 111 by performing the aforementioned remapping.

It should be noted that while it is preferred to have a respective TWBUtilLunThreshold[n][7:0] value associated with each respective TWB 111, in some scenarios it may be sufficient to use the same TWBUtilLunThreshold[n][7:0] value for all of the TWBs. For purposes of describing an example of the preferred embodiment, it is assumed herein that a respective TWBUtilLunThreshold[n][7:0] value is used with each respective TWB 111.

In accordance with a representative embodiment, when logic of the control logic 120 determines that a bWriteBoosterBufferLifeTimeEst value has reached or exceeded the respective TWBUtilLunThreshold[n][7:0] value, a particular bit is set that indicates that the TWB TH value has been reached. In accordance with a representative embodiment, this particular bit is one of the reserved bits of an existing register called WExceptionEventStatus (Bit 7-15: Reserved). When the host processor 101 detects that this bit has been set, it sends a command to the control logic 120 to read the bWriteBoosterBufferLifeTimeEst values stored in the registers 126 and forward them to the host processor 101. The host processor 101 then performs a remapping algorithm that decides the TWB-to-LUN remapping to be performed and sends the remapping information to the control logic 120. The remapping logic 130 of the control logic 120 then performs the corresponding remapping.

In accordance with a representative embodiment: if the bWriteBoosterBufferLifeTimeEst value=01h, this indicates that 10% of the TWB lifetime has been used; if the bWriteBoosterBufferLifeTimeEst value=02h, this indicates has been used; if the that 10% to 20% of the TWB lifetime bWriteBoosterBufferLifeTimeEst value=03h, this indicates that 20% to 30% of the TWB lifetime has been used; if the bWriteBoosterBufferLifeTimeEst value=04h, this indicates that 30% to 40% of the TWB lifetime has been used; if the bWriteBoosterBufferLifeTimeEst value=05h, this indicates that 40% to 50% of the TWB lifetime has been used; if the bWriteBoosterBufferLifeTimeEst value=06h, this indicates that 50% to 60% of the TWB lifetime has been used; if the bWriteBoosterBufferLifeTimeEst value=07h, this indicates that 60% to 70% of the TWB lifetime has been used; if the bWriteBoosterBufferLifeTimeEst value=08h, this indicates that 70% to 80% of the TWB lifetime has been used; if the b WriteBoosterBufferLifeTimeEst value=09h, this indicates that the 80% to 90% of the TWB lifetime has been used; if the bWriteBoosterBufferLifeTimeEst value=0 Ah, this indicates that 90% to 100% of the TWB lifetime has been used; and if the bWriteBoosterBufferLifeTimeEst value=0 Bh, this indicates that the TWB has exceeded its estimated lifetime and write commands are processed as if the TWB has been disabled.

When the host processor 101 configures the UFS device 110 to operate in dedicated mode, it also configures the registers 125 and 126 to have the appropriate TWB TH and TWB lifetime estimate values. Thus, these values can be updated by the host processor 101 based on the needs of the customer or original equipment manufacturer (OEM).

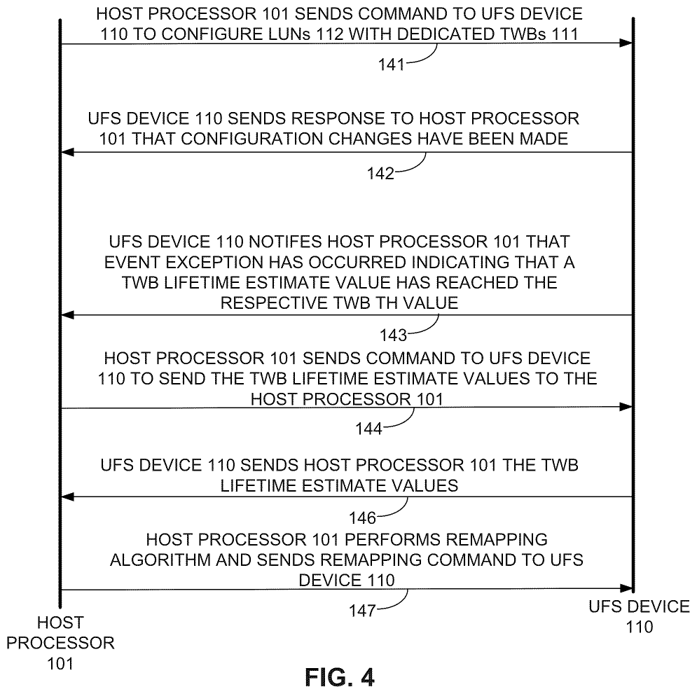

FIG. 4 is a diagram showing the interaction between the host processor 101 and the UFS device 110 in accordance with a representative embodiment. The host processor 101 initially sends a command to the UFS device 110 instructing it to configure the TWBs 111 and the LUNs 112 to operate in the “dedicated mode” discussed above, as indicated by arrow 141. The UFS device 110 then sends a response to the host processor 101 indicating that the configuration changes have been made, as indicated by arrow 142. If the control logic 120 determines that a TWB lifetime estimate value is equal to or greater than the respective TWB TH value, the UFS device 110 notifies the host processor 101 that an event exception has occurred indicating that the TWB lifetime estimate value is equal to or greater than the respective TWB TH value, as indicated by arrow 143. This triggers the host processor 101 to send a command to the UFS device 110 to read all of the other TWB lifetime estimate values contained in registers 126 and send them to the host processor 101, as indicated by arrow 144. The UFS device 110 then reads the registers 126 and forwards the respective TWB lifetime estimate values to the host processor 101, as indicated by block 146. The host processor 101 then performs a remapping algorithm that identifies the TWB lifetime estimate value that is the lowest, i.e., which TWB has the most lifetime remaining, and sends remapping information to the UFS device 110. The TWB-to-LUN mapping logic 130 of the control logic 120 then uses the remapping information to perform remapping by swapping the TWB 111 having the lowest lifetime estimate value with the TWB 111 having the lifetime estimate value that was equal to or greater than the respective TWB TH value.

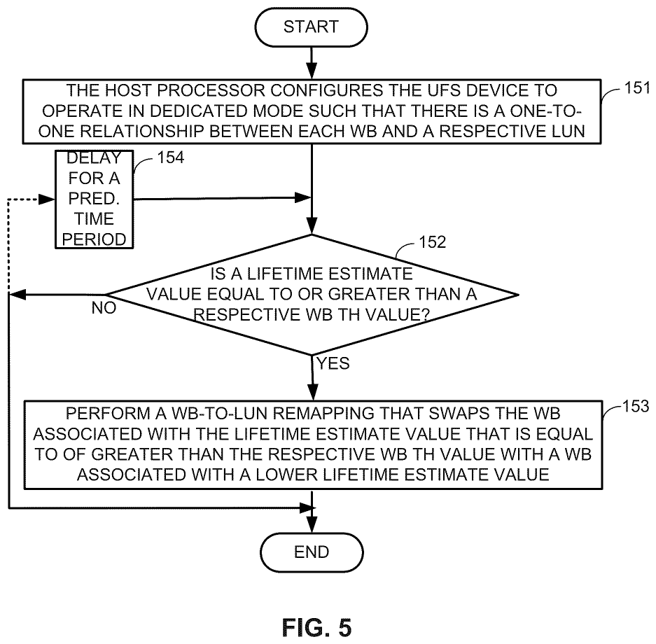

FIG. 5 is a flow diagram representing the method in accordance with a representative embodiment. The host processor configures a UFS device to operate in the dedicated mode of operations in which N write buffers (WBs) are mapped to N LUNs, respectively, such that each WB acts as a WB for one respective LUN, where N is a positive integer that is greater than or equal to two, as indicated by block 151. As indicated above, each of the N WBs has a respective WB lifetime estimate value and a respective lifetime TH value associated therewith. The UFS device determines whether the WB lifetime estimate value associated with at least a first WB of the N WBs is equal to or is greater than the WB TH value associated with the first WB, as indicated by block 152. If a determination is made that the WB lifetime estimate value associated with the first WB is equal to or is greater than the WB TH value associated with the first WB, the first WB is remapped to a second LUN of the N LUNs and a second WB of the N WBs is remapped to the first LUN, as indicated by block 153. The remapping is based at least in part on the WB lifetime estimate value associated with the second WB indicating that the second WB has more lifetime remaining than the first WB. As indicated above, in accordance with the preferred embodiment, the second WB is associated with a lifetime estimate value that is less than all of the other lifetime estimate values associated with all of the other WBs.

If a determination is made at block 152 that the WB lifetime estimate value associated with the first WB is not equal to or greater than the WB TH value associated with the first WB, the entire process can end or the process can delay for a predetermined period of time before reperforming the process represented by block 152, as indicated by block 154. The method represented by FIG. 4 can be performed periodically, but the time periods are not required to be constant. For example, the method could be performed when the UFS device 110 is powered on.

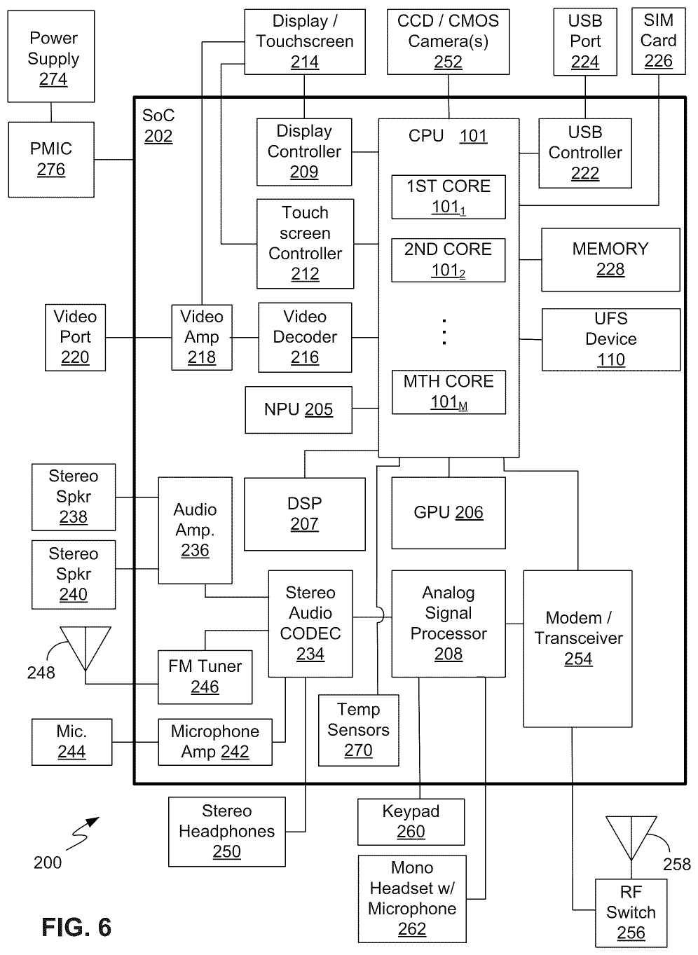

FIG. 6 illustrates an example of a PCD 200, such as a mobile phone, a smartphone, a portable game console such as an Extended Reality (XR) device, a Virtual Reality (VR) device, an Augmented Reality (AR) device, or a Mixed Reality (MR) device, etc., in which exemplary embodiments of systems, methods, computer-readable media, and other examples of the inventive principles and concepts of the present disclosure may be implemented. The PCD 200 comprises an SoC 202, which comprises the system 100 shown in FIG. 3 or a similar system. For purposes of clarity, some interconnects, signals, etc., are not shown in FIG. 6.

The SoC 202 may include a CPU 101 acting as the host processor 101 shown in FIG. 3, an NPU 205, a GPU 206, a DSP 207, an analog signal processor 208, a modem/transceiver 254, or other processors. The CPU 101 may include one or more CPU cores, such as a first CPU core 1011, a second CPU core 1012, etc., through an M^{th} CPU core 101M. For illustrative purposes, it is assumed herein that the CPU 101 acts as the host processor 101 shown in FIGS. 1-3. However, any of the processors shown in FIG. 6, such as DSP 207, NPU 205 and GPU 206, for example, can operate as the host processor 101.

A display controller 209 and a touch-screen controller 212 may be coupled to the CPU 101. A touchscreen display 214 external to the SoC 202 may be coupled to the display controller 209 and the touch-screen controller 212. The PCD 200 may further include a video decoder 216 coupled to the CPU 101. A video amplifier 218 may be coupled to the video decoder 216 and the touchscreen display 214. A video port 220 may be coupled to the video amplifier 218. A universal serial bus (“USB”) controller 222 may also be coupled to CPU 101, and a USB port 224 may be coupled to the USB controller 222. A subscriber identity module (“SIM”) card 226 may also be coupled to the CPU 101.

One or more memories 228 may be coupled to the CPU 101. The one or more memories 228 may include both volatile and non-volatile memories. Examples of volatile memories include static random access memory (“SRAM”) and dynamic random access memory (“DRAM”). Such memories may be external to the SoC 202 or internal to the SoC 202. The one or more memories 228 may include local cache memory and/or a system-level cache memory.

A stereo audio CODEC 234 may be coupled to the analog signal processor 208. An audio amplifier 236 may be coupled to the stereo audio CODEC 234. First and second stereo speakers 238 and 240, respectively, may be coupled to the audio amplifier 236. A microphone amplifier 242 may be coupled to the stereo audio CODEC 234, and a microphone 244 may be coupled to the microphone amplifier 242. A frequency modulation (“FM”) radio tuner 246 may be coupled to the stereo audio CODEC 234. An FM antenna 248 may be coupled to the FM radio tuner 246. Further, stereo headphones 250 may be coupled to the stereo audio CODEC 234. Other devices that may be coupled to the CPU 101 include one or more digital (e.g., CCD or CMOS) cameras 252.

The modem or RF transceiver 254 may be coupled to the analog signal processor 208 and to the CPU 101. An RF switch 256 may be coupled to the RF transceiver 254 and to an RF antenna 258. In addition, a keypad 260 and a mono headset with a microphone 262 may be coupled to the analog signal processor 208. The SoC 202 may have one or more internal or on-chip thermal sensors 270. A power supply 274 and a power management IC (PMIC) 276 may supply power to the SoC 202.

Firmware or software may be stored in any of the above-described memories, or may be stored in a local memory directly accessible by the processor hardware on which the software or firmware executes. Execution of such firmware or software by logic of the UFS device 110 and by the CPU 101 may control aspects of any of the above-described methods or configure aspects of any of the above-described systems. Any such memory or other non-transitory storage medium having firmware or software stored therein in computer-readable form for execution by processor hardware may be an example of a “computer-readable medium,” as the term is understood in the patent lexicon.

Implementation examples are described in the following numbered clauses:

1. A method for improving write performance of a Universal Flash Storage (UFS) device, the UFS device comprising N logical units (LUNs) and N write buffers (WBs), each of the N WBs being mapped to a respective LUN of the N LUNs, where N is a positive integer that is greater than or equal to two, each of the N WBs having a respective WB lifetime estimate value and a respective WB lifetime threshold (TH) value associated therewith, the N WB lifetime estimate values being indicative of an amount of lifetime remaining in the N WBs, respectively, the method comprising:
determining whether the WB lifetime estimate value associated with at least a first WB of the N WBs is equal to or is greater than the respective WB TH value associated with the first WB; and
if a determination is made that the WB lifetime estimate value associated with the first WB is equal to or is greater than the WB TH value associated with the first WB, remapping the first WB to a second LUN of the N LUNs and remapping a second WB of the N WBs to the first LUN, the remapping being based at least in part on the WB lifetime estimate value associated with the second WB indicating that the second WB has more lifetime remaining than the first WB.

2. The method of clause 1, wherein the WB lifetime estimate value associated with the second WB is less than the WB lifetime estimate value associated with the first WB.

3. The method of any of clauses 1 or 2, wherein the WB lifetime estimate value associated with the second WB is less than the WB lifetime estimate values associated with all of the WBs, and wherein the method further comprises:
prior to remapping, comparing the N WB lifetime estimate values to one another and determining that the WB lifetime estimate value associated with the second WB is less than the WB lifetime estimate values associated with all of the other WBs.

4. The method of any of clauses 1-3, wherein the step of determining whether the WB lifetime estimate value associated with at least the first WB is equal to or is greater than the WB TH value associated with the first WB comprises:
determining whether the N WB lifetime estimate values associated with the N WBs are equal to or are greater than the N WB TH values, respectively, associated with the N WBs, respectively.

5. The method of any of clauses 1-5, wherein the N WBs comprise single-level-cell (SLC) NAND flash memory cells and wherein the flash memory cells of the main memory portion of the UFS device comprises triple-level-cell (TLC) NAND flash memory cells.

6. The method of any of clauses 1-5, wherein the step of determining whether the WB lifetime estimate value associated with at least a first WB of the N WBs is equal to or is greater than the respective WB TH value associated with the first WB is performed by control logic of the UFS device.

7. The method of any of clauses 1-6, wherein the step of remapping the first WB to the second LUN of the N LUNs and remapping the second WB of the N WBs to the first LUN is performed in part by a host processor that is in communication with the UFS device via an interface and is performed in part by WB-to-LUN remapping logic of control logic of the UFS device.

8. A system for improving write performance of a flash memory device of the system, the system comprising:
a Universal Flash Storage (UFS) device, the UFS device comprising N logical units (LUNs), N write buffers (WBs) and control logic, each of the N WBs being mapped to a respective LUN of the N LUNs, where N is a positive integer that is greater than or equal to two, each of the N WBs having a respective WB lifetime estimate value and a respective WB lifetime threshold (TH) value associated therewith, the N WB lifetime estimate values being indicative of an amount of lifetime remaining in the N WBs, respectively, and wherein the control logic is configured to determine whether any of the WB lifetime estimate values are equal to or are greater than the respective WB TH values; and
a host processor configured to perform a remapping algorithm if a determination is made that the WB lifetime estimate value associated with at least a first WB of the N WBs is equal to or is greater than the WB TH value associated with the first WB, the remapping algorithm remapping the first WB to a second LUN of the N LUNs and remapping a second WB of the N WBs to the first LUN, wherein the remapping is based at least in part on the WB lifetime estimate value associated with the second WB indicating that the second WB has more lifetime remaining than the first WB.

9. The system of clause 8, wherein the WB lifetime estimate value associated with the second WB is less than the WB lifetime estimate value associated with the first WB.

10. The system of any of clauses 8-9, wherein the WB lifetime estimate value associated with the second WB is less than the WB lifetime estimate values associated with all of the WBs, and wherein the host processor further comprises:
logic configured to perform a comparison algorithm prior to performing the remapping algorithm, the comparison algorithm comparing the N WB lifetime estimate values to one another to determine which of the WB lifetime estimate values is less than all of the other WB lifetime estimate values, and wherein the WB lifetime estimate value associated with the second WB is less than the WB lifetime estimate values associated with all of the other WBs.

11. The system of any of clauses 8-10, wherein the N WBs comprise single-level-cell (SLC) NAND flash memory cells and wherein the UFS device comprises triple-level-cell (TLC) NAND flash memory cells that are accessed via the N LUNs.

12. The system of any of clauses 8-11, wherein the system is embedded in a System-On-A-Chip (SoC) integrated circuit (IC) package of a portable computing device (PCD).

13. The system of any of clauses 8-12, further comprising:
WB-to-LUN remapping logic that receives results of the remapping algorithm performed by the logic of the host processor completes remapping the first WB to the second LUN of the N LUNs and remapping the second WB of the N WBs to the first LUN.

14. The system of any of clauses 8-13, further comprising:
N WB TH registers configured to store the N WB TH values, the control logic being configured to write and read the N WB TH registers; and
N WB lifetime estimate registers configured to store the N WB lifetime estimate values, the control logic being configured to write and read the N WB TH registers.

15. A computer program embodied on a non-transitory computer-readable medium and comprising computer instructions for execution by a processor or controller for improving write performance of a Universal Flash Storage (UFS) device, the UFS device comprising N logical units (LUNs) and N write buffers (WBs), each of the N WBs being mapped to a respective LUN of the N LUNs, where N is a positive integer that is greater than or equal to two, each of the N WBs having a respective WB lifetime estimate value and a respective WB lifetime threshold (TH) value associated therewith, the N WB lifetime estimate values being indicative of an amount of lifetime remaining in the N WBs, respectively, the computer program comprising:
a first set of instructions for determining whether the WB lifetime estimate value associated with at least a first WB of the N WBs is equal to or is greater than the respective WB TH value associated with the first WB; and
a second set of computer instructions, wherein if a determination is made that the WB lifetime estimate value associated with the first WB is equal to or is greater than the WB TH value associated with the first WB, the second set of computer instructions remaps the first WB to a second LUN of the N LUNs and remaps a second WB of the N WBs to the first LUN, the remapping being based at least in part on the WB lifetime estimate value associated with the second WB indicating that the second WB has more lifetime remaining than the first WB.

16. The computer program of clause 15, wherein the WB lifetime estimate value associated with the second WB is less than the WB lifetime estimate value associated with the first WB.

17. The computer program of any of clauses 15-16, wherein the WB lifetime estimate value associated with the second WB is less than the WB lifetime estimate values associated with all of the WBs, and wherein the computer program further comprises:
a third set of computer instructions that is performed prior to the second set of computer instructions being performed, the third set of computer instructions comparing the N WB lifetime estimate values to one another to determine which of the WB lifetime estimate values is the lowest WB lifetime estimate value, and wherein the WB lifetime estimate value associated with the second WB is less than the WB lifetime estimate values associated with all of the other WBs.

18. The computer program of any of clauses 15-17, wherein the first set of computer instructions for determining whether the WB lifetime estimate value associated with at least the first WB is equal to or is greater than the WB TH value associated with the first WB comprises:
computer instructions for determining whether the N WB lifetime estimate values associated with the N WBs are equal to or are greater than the N WB TH values, respectively, associated with the N WBs, respectively.

19. The computer program of any of clauses 15-18, wherein the N WBs comprise single-level-cell (SLC) NAND flash memory cells and wherein the flash memory cells of the main memory portion of the UFS device comprises triple-level-cell (TLC) NAND flash memory cells.

Alternative embodiments will become apparent to one of ordinary skill in the art to which the invention pertains in view of the present disclosure. Therefore, although selected aspects have been illustrated and described in detail, it will be understood that various substitutions and alterations may be made therein.

What is claimed is:

1. A method for improving write performance of a Universal Flash Storage (UFS) device, the UFS device comprising N logical units (LUNs) and N write buffers (WBs), each of the N WBs being mapped to a respective LUN of the N LUNs, where N is a positive integer that is greater than or equal to two, each of the N WBs having a respective WB lifetime estimate value and a respective WB lifetime threshold (TH) value associated therewith, the N WB lifetime estimate values being indicative of an amount of lifetime remaining in the N WBs, respectively, the method comprising:
determining whether the WB lifetime estimate value associated with at least a first WB of the N WBs is equal to or is greater than the respective WB TH value associated with the first WB; and
if a determination is made that the WB lifetime estimate value associated with the first WB is equal to or is greater than the WB TH value associated with the first WB, remapping the first WB to a second LUN of the N LUNs and remapping a second WB of the N WBs to the first LUN, the remapping being based at least in part on the WB lifetime estimate value associated with the second WB indicating that the second WB has more lifetime remaining than the first WB.

2. The method of claim 1, wherein the WB lifetime estimate value associated with the second WB is less than the WB lifetime estimate value associated with the first WB.

3. The method of claim 2, wherein the WB lifetime estimate value associated with the second WB is less than the WB lifetime estimate values associated with all of the WBs, and wherein the method further comprises:
prior to remapping, comparing the N WB lifetime estimate values to one another and determining that the WB lifetime estimate value associated with the second WB is less than the WB lifetime estimate values associated with all of the other WBs.

4. The method of claim 3, wherein the step of determining whether the WB lifetime estimate value associated with at least the first WB is equal to or is greater than the WB TH value associated with the first WB comprises:
determining whether the N WB lifetime estimate values associated with the N WBs are equal to or are greater than the N WB TH values, respectively, associated with the N WBs, respectively.

5. The method of claim 1, wherein the N WBs comprise single-level-cell (SLC) NAND flash memory cells and wherein the flash memory cells of the main memory portion of the UFS device comprises triple-level-cell (TLC) NAND flash memory cells.

6. The method of claim 1, wherein the step of determining whether the WB lifetime estimate value associated with at least a first WB of the N WBs is equal to or is greater than the respective WB TH value associated with the first WB is performed by control logic of the UFS device.

7. The method of claim 6, wherein the step of remapping the first WB to the second LUN of the N LUNs and remapping the second WB of the N WBs to the first LUN is performed in part by a host processor that is in communication with the UFS device via an interface and is performed in part by WB-to-LUN remapping logic of control logic of the UFS device.

8. A system for improving write performance of a flash memory device of the system, the system comprising:
a Universal Flash Storage (UFS) device, the UFS device comprising N logical units (LUNs), N write buffers (WBs) and control logic, each of the N WBs being mapped to a respective LUN of the N LUNs, where N is a positive integer that is greater than or equal to two, each of the N WBs having a respective WB lifetime estimate value and a respective WB lifetime threshold (TH) value associated therewith, the N WB lifetime estimate values being indicative of an amount of lifetime remaining in the N WBs, respectively, and wherein the control logic is configured to determine whether any of the WB lifetime estimate values are equal to or are greater than the respective WB TH values; and
a host processor configured to perform a remapping algorithm if a determination is made that the WB lifetime estimate value associated with at least a first WB of the N WBs is equal to or is greater than the WB TH value associated with the first WB, the remapping algorithm remapping the first WB to a second LUN of the N LUNs and remapping a second WB of the N WBs to the first LUN, wherein the remapping is based at least in part on the WB lifetime estimate value associated with the second WB indicating that the second WB has more lifetime remaining than the first WB.

9. The system of claim 8, wherein the WB lifetime estimate value associated with the second WB is less than the WB lifetime estimate value associated with the first WB.

10. The system of claim 9, wherein the WB lifetime estimate value associated with the second WB is less than the WB lifetime estimate values associated with all of the WBs, and wherein the host processor further comprises:
logic configured to perform a comparison algorithm prior to performing the remapping algorithm, the comparison algorithm comparing the N WB lifetime estimate values to one another to determine which of the WB lifetime estimate values is less than all of the other WB lifetime estimate values, and wherein the WB lifetime estimate value associated with the second WB is less than the WB lifetime estimate values associated with all of the other WBs.

11. The system of claim 8, wherein the N WBs comprise single-level-cell (SLC) NAND flash memory cells and wherein the UFS device comprises triple-level-cell (TLC) NAND flash memory cells that are accessed via the N LUNs.

12. The system of claim 8, wherein the system is embedded in a System-On-A-Chip (SoC) integrated circuit (IC) package of a portable computing device (PCD).

13. The system of claim 8, further comprising:
WB-to-LUN remapping logic that receives results of the remapping algorithm performed by the logic of the host processor completes remapping the first WB to the second LUN of the N LUNs and remapping the second WB of the N WBs to the first LUN.

14. The system of claim 13, further comprising:
N WB TH registers configured to store the N WB TH values, the control logic being configured to write and read the N WB TH registers; and
N WB lifetime estimate registers configured to store the N WB lifetime estimate values, the control logic being configured to write and read the N WB TH registers.

15. A computer program embodied on a non-transitory computer-readable medium and comprising computer instructions for execution by a processor or controller for improving write performance of a Universal Flash Storage (UFS) device, the UFS device comprising N logical units (LUNs) and N write buffers (WBs), each of the N WBs being mapped to a respective LUN of the N LUNs, where N is a positive integer that is greater than or equal to two, each of the N WBs having a respective WB lifetime estimate value and a respective WB lifetime threshold (TH) value associated therewith, the N WB lifetime estimate values being indicative of an amount of lifetime remaining in the N WBs, respectively, the computer program comprising:
a first set of instructions for determining whether the WB lifetime estimate value associated with at least a first WB of the N WBs is equal to or is greater than the respective WB TH value associated with the first WB; and
a second set of computer instructions, wherein if a determination is made that the WB lifetime estimate value associated with the first WB is equal to or is greater than the WB TH value associated with the first WB, the second set of computer instructions remaps the first WB to a second LUN of the N LUNs and remaps a second WB of the N WBs to the first LUN, the remapping being based at least in part on the WB lifetime estimate value associated with the second WB indicating that the second WB has more lifetime remaining than the first WB.

16. The computer program of claim 15, wherein the WB lifetime estimate value associated with the second WB is less than the WB lifetime estimate value associated with the first WB.

17. The computer program of claim 16, wherein the WB lifetime estimate value associated with the second WB is less than the WB lifetime estimate values associated with all of the WBs, and wherein the computer program further comprises:
a third set of computer instructions that is performed prior to the second set of computer instructions being performed, the third set of computer instructions comparing the N WB lifetime estimate values to one another to determine which of the WB lifetime estimate values is the lowest WB lifetime estimate value, and wherein the WB lifetime estimate value associated with the second WB is less than the WB lifetime estimate values associated with all of the other WBs.

18. The computer program of claim 15, wherein the first set of computer instructions for determining whether the WB lifetime estimate value associated with at least the first WB is equal to or is greater than the WB TH value associated with the first WB comprises:
computer instructions for determining whether the N WB lifetime estimate values associated with the N WBs are equal to or are greater than the N WB TH values, respectively, associated with the N WBs, respectively.

19. The computer program of claim 15, wherein the N WBs comprise single-level-cell (SLC) NAND flash memory cells and wherein the flash memory cells of the main memory portion of the UFS device comprises triple-level-cell (TLC) NAND flash memory cells.

20. The computer program of claim 15, wherein first set of computer instructions is executed by control logic of the UFS device.
